(19) United States
(12) Patent Application Publication
(10) Pub. No.: US 2008/0243614 A1
(43) Pub. Date: Oct. 2, 2008

(54) ADAPTIVE ADVERTISING AND MARKETING SYSTEM AND METHOD

(75) Inventors: Peter Henry Tu, Niskayuna, NY (US); Nils Oliver Krahnstoever, Schenectady, NY (US); Timothy Patrick Kelliher, Scotia, NY (US); Xiaoming Liu, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/858,292

(22) Filed: Sep. 20, 2007

Related U.S. Application Data
(60) Provisional application No. 60/908,991, filed on Mar. 30, 2007.

(51) Int. Cl. G06Q 30/00

(52) U.S. Cl. 705/14

(57) ABSTRACT

A technique of adaptive advertising is provided. The technique includes obtaining at least one of demographic and behavioral profiles of a plurality of individuals in an environment and adjusting an advertising strategy in the environment of one or more products based upon the demographic and behavioral profiles of the plurality of individuals.

### CROSS REFERENCE TO RELATED APPLICATIONS

This application claims priority to U.S. Provisional Application No. 60/908,991, filed on Mar. 30, 2007.

### BACKGROUND

The invention relates generally to computer vision techniques and, more particularly to, computer vision techniques for adaptive advertising and marketing for retail applications.

Due to increasing competition and shrinking margins in the retail environments, retailers are interested in understanding the behaviors and purchase decision processes of their customers. Further, it is desirable to use this information in determining the advertising and/or marketing strategy for products. Typically, such information is obtained through direct observation of shoppers or indirectly via focus groups or specialized experiments in controlled environments. In particular, data is gathered using video, audio and other sensors observing people reacting to products. To obtain the information regarding the behaviors of the customers, several inspection techniques have been used. For example, downward looking stereo cameras are employed to track location of the shoppers in the retail environment. However, this requires dedicated stereo sensors, which are expensive and are uncommon in retail environments.

The gathered information regarding the behaviors of the shoppers is analyzed to determine factors of importance to marketing analysis. However, such process is labor-intensive and has low reliability. Therefore, manufacturers of products in the retail environment have to rely upon manual assessments and product sales as a guiding factor to determine success or failure of the products. Additionally, the current store advertisements are static entities and cannot be adjusted to enhance the sales of the products.

It is therefore desirable to provide a real-time, efficient, reliable, and cost-effective technique for obtaining information regarding behaviors of the shoppers in a retail environment. It is also desirable to provide techniques that enable adjusting the advertising and marketing strategy of the products based upon the obtained information.

### BRIEF DESCRIPTION

Briefly, in accordance with one aspect of the invention, a method of adaptive advertising is provided. The method provides for obtaining at least one of demographic and behavioral profiles of a plurality of individuals in an environment and adjusting an advertising strategy in the environment of one or more products based upon the demographic and behavioral profiles of the plurality of individuals. Systems that afford such functionality may be provided by the present technique.

In accordance with another aspect of the present technique, a method is provided for enhancing sales of one or more products in a retail environment. The method provides for obtaining information regarding behavioral profiles of a plurality of individuals visiting the retail environment, analyzing the obtained information regarding the behavioral profiles of the individuals and changing at least one of an advertising strategy or a product marketing strategy of the one or more products in response to the information regarding the behavioral profiles of the plurality of individuals. Here again, systems affording such functionality may be provided by the present technique.

In accordance with a further aspect of the present technique, an adaptive advertising and marketing system is provided. The system includes a plurality of imaging devices, each device being configured to capture an image of one or more individuals in an environment and a video analytics system configured to receive captured images from the plurality of imaging devices and to extract at least one of demographic and behavioral profiles of the one or more individuals to change at least one of an advertising or a product market strategy of one or more products.

These and other advantages and features will be more readily understood from the following detailed description of preferred embodiments of the invention that is provided in connection with the accompanying drawings.

### DRAWINGS

FIG. 1 is a schematic diagram of an adaptive advertising and marketing system in accordance with an embodiment of the invention.

FIG. 2 depicts an exemplary path of a shopper within a retail environment in accordance with an embodiment of the invention.

FIG. 3 depicts arrival and departure information of shoppers visiting a retail environment in accordance with an embodiment of the invention.

FIG. 4 depicts face model fitting and gaze estimation of a shopper observing products in a retail environment in accordance with an embodiment of the invention.

FIG. 5 depicts exemplary mean and observed shape bases for estimating the gaze of a shopper in accordance with an embodiment of the invention.

FIG. 6 depicts an enhanced active appearance model technique for estimating the gaze of a shopper in accordance with an embodiment of the invention.

FIG. 7 depicts exemplary head gazes of a shopper observing products in a retail environment in accordance with an embodiment of the invention.

FIG. 8 depicts a gaze trajectory of the shopper of FIG. 4 in accordance with an embodiment of the invention.

FIG. 9 depicts exemplary average time spent by shoppers observing products displayed in different areas in accordance with an embodiment of the invention.

FIG. 10 is a schematic diagram of another adaptive advertising and marketing system in accordance with an embodiment of the invention.

### DETAILED DESCRIPTION

Embodiments of the invention are generally directed to detection of behaviors of individuals in an environment. Such techniques may be useful in a variety of applications such as marketing, merchandising, store operations and data mining that require efficient, reliable, cost-effective, and rapid monitoring of movement and behaviors of individuals. Although examples are provided herein in the context of retail environments, one of ordinary skill in the art will readily comprehend that embodiments may be utilized in other contexts and remain within the scope of the invention.

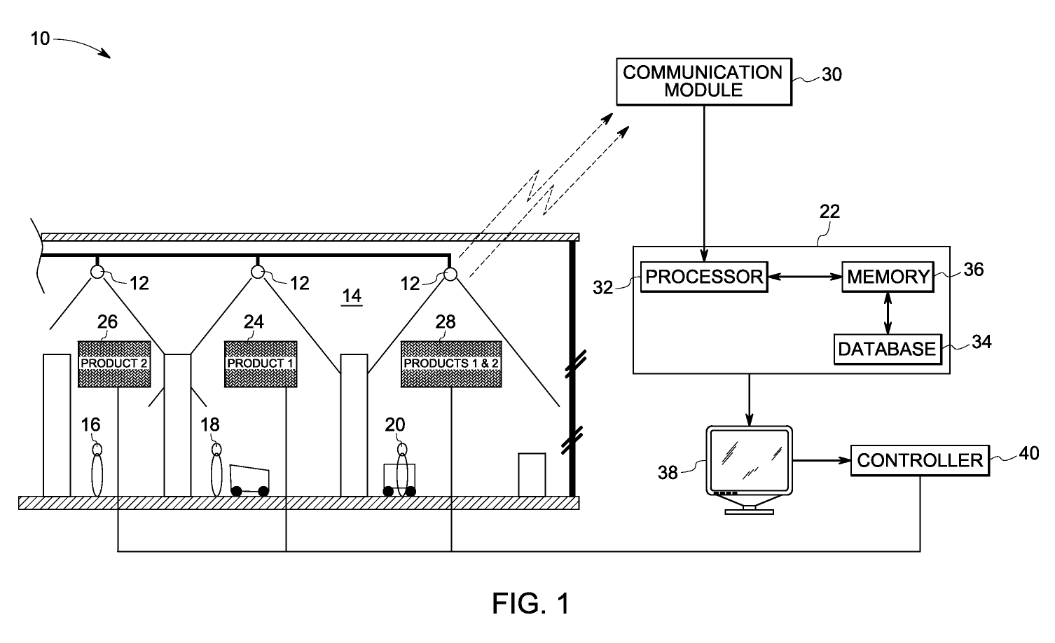

Referring now to FIG. 1, a schematic diagram of an adaptive advertising and marketing system 10 is illustrated. The system 10 includes a plurality of imaging devices 12 located at various locations in an environment 14. Each of the imaging devices 12 is configured to capture an image of one or more individuals such as represented by reference numerals 16, 18 and 20 in the environment 14. The imaging devices 12 may include still cameras. Alternately, the imaging devices 12 may include video cameras. In certain embodiments, the imaging devices 12 may include a network of still or video cameras or a closed circuit television (CCTV) network. In certain embodiments, the environment 14 includes a retail facility and the individuals 16, 18 and 20 include shoppers visiting the retail facility 14. The plurality of imaging devices 12 are configured to monitor and track the movement of the one or more individuals 16, 18 and 20 within the environment 14.

The system 10 further includes a video analytics system 22 configured to receive captured images from the plurality of imaging devices 12 and to extract at least one of demographic and behavioral profiles of the one or more individuals 16, 18 and 20. Further, the demographic and behavioral profiles of the one or more individuals 16, 18 and 20 are utilized to change an advertising strategy of one or more products available in the environment 14. Alternately, the demographic and behavioral profiles of the one or more individuals 16, 18 and 20 are utilized to change a product market strategy of the one or more products available in the environment 14. As used herein, the term “demographic profiles” refers to information regarding a demographic grouping of the one or more individuals 16, 18 and 20 visiting the environment 14. For example, the demographic profiles may include information regarding age bands, social class bands and gender of the one or more individuals 16, 18 and 20.

The behavioral profiles of the one or more individuals 16, 18 and 20 include information related to interaction of the one or more individuals 16, 18 and 20 with the one or more products. Moreover, the behavioral profiles also includes information related to interaction of the one or more individuals 16, 18 and 20 with products displays such as represented by reference numerals 24, 26 and 28. Examples of such information include, but are not limited to, a gaze direction of the individuals 16, 18 and 20, time spent by the individuals 16, 18 and 20 in browsing the product displays 24, 26 and 28, time spent by the individuals 16, 18 and 20 while interacting with the one or more products, number of eye gazes towards the one or more products or the product displays 24, 26 and 28.

The system 10 also includes one or more communication modules 30 disposed in the facility 14, and optionally at a remote location, to transmit still images or video signals to the video analytics server 22. The communication modules 30 include wired or wireless networks, which communicatively link the imaging devices 12 to the video analytics server 22. For example, the communication modules 16 may operate via telephone lines, cable lines, Ethernet lines, optical lines, satellite communications, radio frequency (RF) communications, and so forth.

The video analytics server 22 includes a processor 32 configured to process the still images or video signals and to extract the demographic and behavioral profiles of the one or more individuals 16, 18 and 20. Further, the video analytics server 22 includes a variety of software and hardware for performing facial recognition of the one or more individuals 16, 18 and 20 entering and traveling about the facility 14. For example, the video analytics server 22 may include file servers, application servers, web servers, disk servers, database servers, transaction servers, telnet servers, proxy servers, mail servers, list servers, groupware servers, File Transfer Protocol (FTP) servers, fax servers, audio/video servers, LAN servers, DNS servers, firewalls, and so forth.

The video analytics server 22 also includes one or more databases 34 and memory 36. The memory 36 may include hard disk drives, optical drives, tape drives, random access memory (RAM), read-only memory (ROM), programmable read-only memory (PROM), Redundant Arrays of Independent Disks (RAID), flash memory, magneto-optical memory, holographic memory, bubble memory, magnetic drum, memory stick, Mylar® tape, smartdisk, thin film memory, zip drive, and so forth. The database 34 may utilize the memory 36 to store facial images of the one or more individuals 16, 18 and 20, information about location of the individuals 16, 18 and 20, and other data or code to obtain behavioral and demographic profiles of the individuals 16, 18 and 20. Moreover, the system 10 includes a display 38 configured to display the demographic and behavioral profiles of the one or more individuals 16, 18 and 20 to a user of the system 10.

In operation, each imaging device 12 may acquire a series of images including facial images of the individual 16, 18 and 20 as they visit different sections within the environment 14. It should be noted that the plurality of imaging devices 12 are configured to obtain information regarding number and location of the one or more individuals 16, 18 and 20 visiting the different sections of the environment 14. The captured images from the plurality of imaging devices 12 are transmitted to the video analytics system 22. Further, the processor 32 is configured to process the captured images and to extract the demographic and behavioral profiles of the one or more individuals 16, 18 and 20.

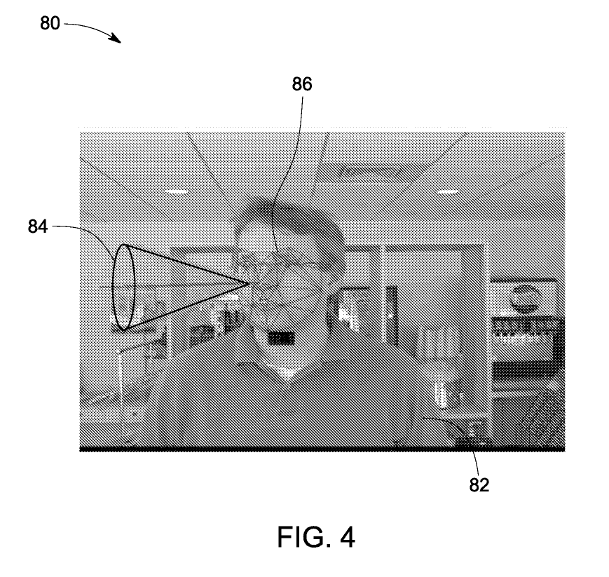

In particular, the movement of the one or more individuals 16, 18 and 20 is tracked within the environment 14 and information regarding the demographics and behaviors of the individuals 16, 18 and 20 is extracted using the captured images via the imaging devices 12. In certain embodiments, information regarding an articulated motion, or a facial expression of the one or more individuals 16, 18 and 20 is extracted using the captured images. In certain embodiments, a customer gaze is determined for the individuals 16, 18 and 20 using face models such as active appearance models (AAM) that will be described in detail below with reference to FIG.4. In certain embodiments, the video analytics server 22 may employ a statistical model to determine an emotional state of each of the individuals 16, 18 and 20 as they interact with the products or the products displays 24, 26 and 28. In one exemplary embodiment, the statistical model may include a graphical model where the emotional state of the individuals 16, 18 and 20 may be considered as a hidden variable to be inferred by the observable behavior.

The demographic and behavioral profiles of the one or more individuals 16, 18 and 20 are further utilized to change the advertising or a product market strategy of the one or more products available in the environment. In particular, the processor 32 is configured to analyze the demographic and behavioral profiles and other information related to the one or more individuals 16, 18 and 20 and to develop a modified advertising or a product market strategy of the one or more products. For example, the modified advertising strategy may include customizing the product displays 24, 26 and 28 based upon the extracted demographic and behavioral profiles of the one or more individuals 16, 18 and 20.

Further, the modified product market strategy may include changing a location of the one or more products in the environment 14. Alternatively, the modified product market strategy may include changing a design or a quality of the one or more products in the environment 14. The modified advertising or a product market strategy of the one or more products may be made available to a user through the display 38. In certain the modified advertising strategy may be communicated to a controller 40 for controlling content of the product displays 24, 26 and 28 based upon the modified advertising strategy.

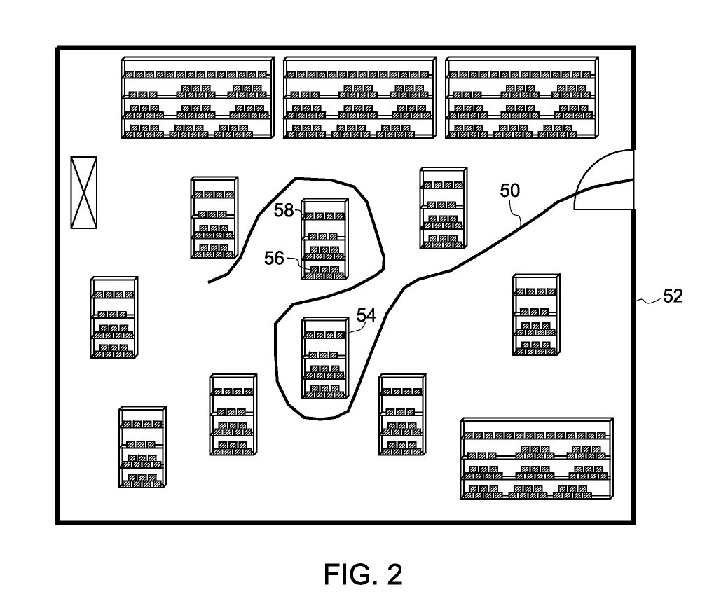

FIG. 2 depicts an exemplary path 50 of a shopper (not shown) within a retail environment 52. The shopper may visit a plurality of sections within the environment 52 and may observe a plurality of products such as represented by reference numerals 54, 56 and 58 displayed at different locations within the environment 52. The plurality of imaging devices 12 (FIG. 1) are configured to capture images of the shoppers visiting the environment to track the location of the shopper within the environment 52. The plurality of imaging devices 12 may utilize calibrated camera views to constrain the location of the shoppers within the environment 52 which facilitates locating shoppers even under crowded conditions. In certain embodiments, the imaging devices 12 follow a detect and track paradigm where the process of person detection and tracking are kept separate.

The processor 32 (FIG. 1) is configured to receive the captured images from the imaging devices 12 to obtain the information regarding number and location of the shoppers within the environment 52. In certain embodiments, the processor 32 utilizes segmentation information from a foreground background segmentation front-end as well as the image content to determine at each frame an estimate of the most likely configuration of shoppers that could have generated the given imagery. The configuration of targets (i.e. shoppers) with ground plane locations (xⱼ,yⱼ) within the facility 52 may be defined as:

X={Xⱼ=(xⱼ,yⱼ), j=0, . . . ,Nₜ} (1)

Each of the targets is associated with size and height information. Additionally, the target is composed of several parts. For example, a part k of the target may be denoted by Oₖ. When the target configuration X is projected into the image, a label image denoted by Oᵢ=kᵢ may be generated where at each image location i part kᵢ is visible. It should be noted that if no part is visible, then Oᵢ may be assigned a background label denoted by BG.

The probability of the foreground image F at time is represented by the following equation:

$$p ( {F}_{t} \vert X ) = {\prod }_{allk} {}_{{}_{{\prod }_{\{ i \vert i ∈ BG \}} p ( {F}_{t} [ i ] \vert i ∈ BG )}} [ {\prod }_{\{ i \vert O [ i ] = k \}} p ( {F}_{t} [ i ] O [ i ] ) ] \qquad ( 2 )$$

where: Fₜ[i] represents discretized probability of seeing foreground at image location i. The above equation (2) may be simplified to the following equation where constant contributions from the background BG may be factored out during optimization:

$$L ( {F}_{t} \vert X ) = {\sum }_{\{ i \vert O [ i ] \neq BG \}} {h}_{O [ i ]} ( {F}_{t} [ i ] ) \qquad ( 3 )$$

where hₖ(p) represents a histogram of likelihood ratios for part k given foreground pixel probabilities p.

The goal of the shopper detection task is to find the most likely target configuration (X) that maximizes equation (3). As will be appreciated by one skilled in the art certain assumptions and approximations may be made to facilitate real time execution of the shopper detection task. For example, projected ellipsoids may be approximated by their bounding boxes. Further, the bounding boxes may be subdivided into one or more several parts and separate body part labels may be assigned to top, middle and bottom third of the bounding box. In certain embodiments, targets may only be located at discrete ground plane locations in the camera view that allows a user to pre-compute the bounding boxes.

Once a shopper is detected in the environment 52, his movement and location is tracked as the shopper moves within the environment 52. The tracking of the shopper is performed in a similar manner as described above. In particular, at every step, detections are projected into the ground plane and may be supplied to a centralized tracker (not shown) that sequentially processes the locations of these detections from all camera views. Thus, tracking of extended targets in the imagery is reduced to tracking of two-dimensional point locations in the ground plane. In certain embodiments, the central tracker may operate on a physically separate processing node, connected to individual processing units that perform detection using a network connection. Further, the detections may be time stamped according to a synchronous clock, buffered and re-ordered by the central tracker before processing. In certain embodiments, the tracking may be performed using a joint probabilistic data association filter (JPDAF) algorithm. Alternatively, the tracking may be performed using Bayesian multi-target trackers. However, other tracking algorithms may be employed.

As described above, the shopping path 50 of the shopper may be tracked using the method described above. The tracking of shopping path 50 of shoppers in the environment 52 provides information such as about frequently visited sections of the environment 52 by the shoppers, time spent by the shoppers within different sections of the environment and so forth. Such information may be utilized to adjust the advertising or a product market strategy for enhancing sales of the one or more products available in the environment 52. For example, the location of the one or more products may be adjusted based upon such information. Further, location of the product displays and content displayed on the product displays may be adjusted based upon such information.

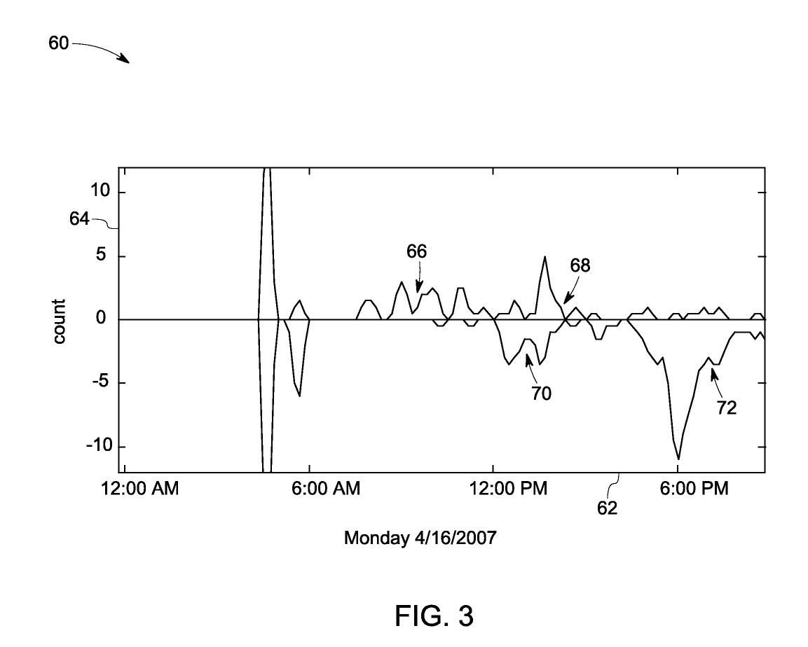

FIG. 3 depicts arrival and departure information 60 of shoppers visiting a retail environment in accordance with an embodiment of the invention. The abscissa axis represents a time 62 of a day and the ordinate axis represents number of shoppers 64 entering or leaving the retail environment. As discussed above, the processor 32 (FIG. 1) is configured to receive the captured images from the imaging devices 12 to obtain the information regarding number and location of the shoppers within the environment 52. A plurality of imaging devices 12 may be located at an entrance and an exit of the retail environment to track shoppers entering and exiting the retail environment. As represented by reference numeral 66, a number of shoppers may enter the retail environment between about 6.00 am and 12.00 pm. Further, shoppers may also enter the retail environment during a lunch period, as represented by reference numeral 68. Additionally, a number of shoppers may leave the retail environment during the lunch period, such as represented by reference numeral 70. Similarly, as represented by reference numeral 72, a number of shoppers may leave the retail environment in evening between about 5:00 pm to about 6:00 pm.

The arrival and departure information 60 may be utilized for adjusting the advertising strategy for the one or more products in the retail environment. In certain embodiments, such information 60 may be utilized to determine the staffing requirements for the retail environment during the day. Further, in certain embodiments, the arrival and departure information along with the demographic profiles of one or more individuals visiting the retail environment may be utilized to customize the advertising strategy of the one or more products.

Additionally, the captured images from the imaging devices 12 are processed to extract the behavioral profiles of the shoppers visiting the retail environment. In certain embodiments, a plurality of in-shelf imaging devices may be employed for estimating the gaze direction of the shoppers. FIG. 4 depicts face model fitting and gaze estimation 80 of a shopper 82 observing products in a retail environment. The video analytics system 22 (FIG. 1) is configured to receive captured images of the shoppers from the in-shelf imaging devices. Further, the system is configured to estimate a gaze direction 84 of the shoppers by fitting active appearance models (AAM) 86 to facial images of the shoppers.

An AAM 86 applied to faces of a shopper is a two-stage model including a facial shape and appearance designed to fit the faces of different persons at different orientations. The shape model describes a distribution of locations of a set of land-mark points. In certain embodiments, principal component analysis (PCA) may be used to reduce a dimensionality of a shape space while capturing major modes of variation across a training set population. PCA is a statistical method for analysis of factors that reduces the large dimensionality of the data space (observed variables) to a smaller intrinsic dimensionality of feature space (independent variables) that describes the features of the image. In other words, PCA can be utilized to predict the features, remove redundant variants, extract relevant features, compress data, and so forth.

A generic AAM is trained using the training set having a plurality of images. Typically, the images come from different subjects to ensure that the trained AAM covers shapes and appearance variation of a relative large population. Advantageously, the trained AAM can be used to fit to facial image from an unseen object. Furthermore, model enhancement may be applied on the AAM trained with the manual labels.

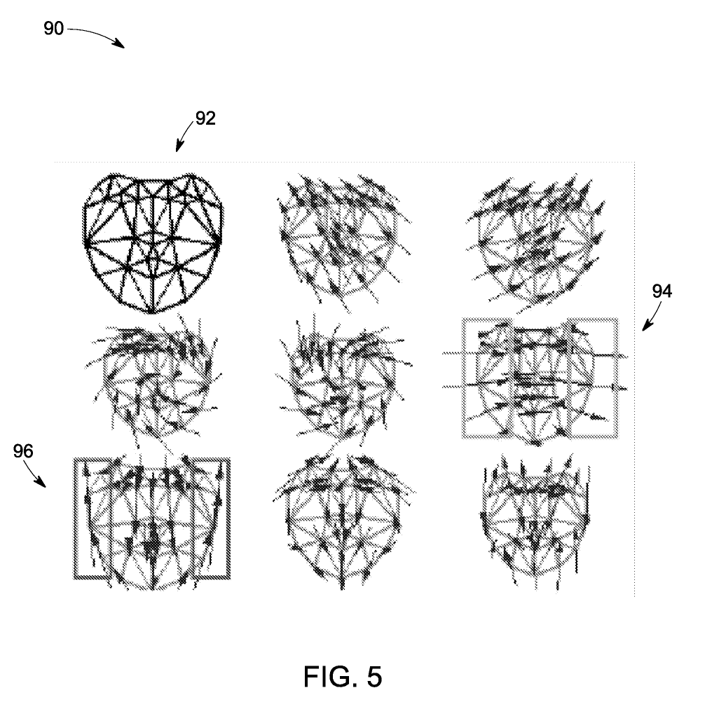

FIG. 5 depicts exemplary mean and observed shape bases 90 for estimating the gaze of a shopper. The AAM shape model 90 includes a mean face shape 92 that is typically an average of all face shapes in the training set and a set of eigen vectors. In certain embodiments, the mean face shape 92 is a canonical shape and is utilized as a frame of reference for the AAM appearance model. Further, each training set image may be warped to the canonical shape frame of reference to substantially eliminate shape variation of the training set images. Moreover, variation in appearance of the faces may be modeled in second stage using PCA to select a set of appearance eigenvectors for dimensionality reduction.

It should be noted that a completely trained AAM can synthesize face images that vary continuously over appearance and shape. In certain embodiments, AAM is fit to a new face as it appears in a video frame. This may be achieved by solving for the face shape such that model synthesized face matches the face in the video frame warped with the shape parameters. In certain embodiments, simultaneous inverse compositional (SIC) algorithm may be employed to solve the fitting problem. Further, shape parameters may be utilized for estimating the gaze of the shopper.

In certain embodiments, facial images with various head poses may be used in the AAM training. As illustrated in FIG. 5, the shapes represented by reference numerals 94 and 96 correspond to horizontal head rotation and vertical head rotation respectively. These shapes may be utilized to determining the shape parameters for estimating the gaze of the shopper.

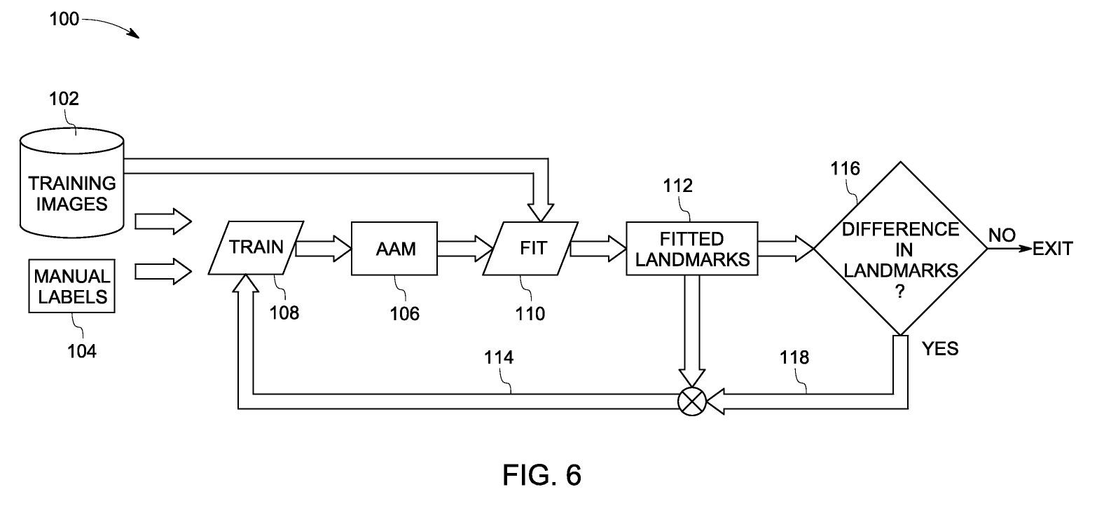

FIG. 6 depicts an enhanced active appearance model technique 100 for estimating the gaze of a shopper. As illustrated, a set of training images 102 and manual labels 104 are used to train an AAM 106, as represented by reference numeral 108. Further, the AAM 106 is fit to the same training images 102, as represented by reference numeral 110. The AAM 106 is fit to the images 102 using the SIC algorithm where the manual labels 104 are used as the initial location for fitting. This fitting yields new landmark positions 112 for the training images 102. Further, the process is iterated, as represented by reference numeral 114 and the new landmark set is used for the face modeling followed by the model fitting using the new AAM. Further, as represented by reference numeral 118, the iteration continues until there is no significant difference 116 between the landmark locations of the current iteration and the previous iteration.

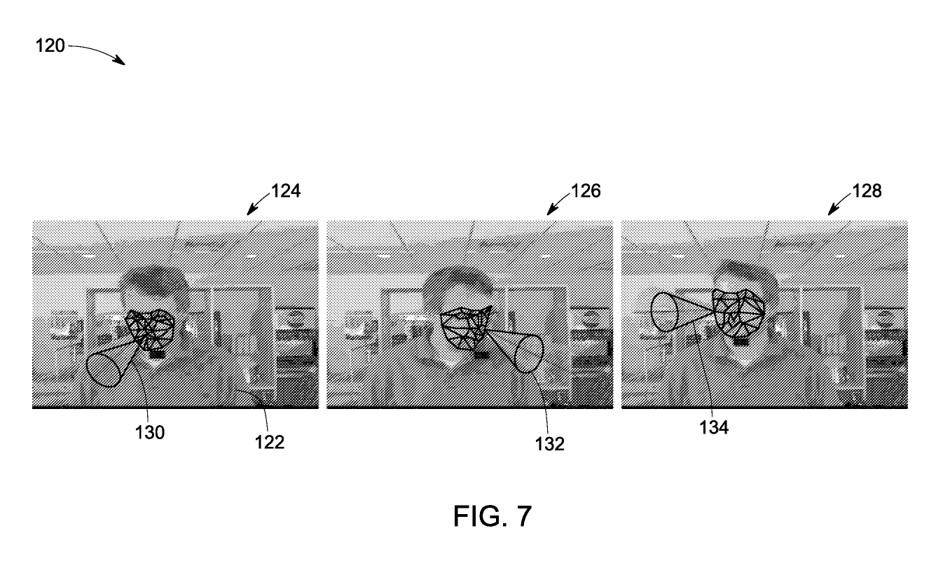

FIG. 7 depicts exemplary head gazes 120 of a shopper 122 observing products in a retail environment. Images 124, 126 and 128 represent shopper having gaze directions 130, 132 and 134 respectively. The gaze directions 130, 132 and 134 are indicative of interaction of the shopper with the products displayed in the retail environment. In certain embodiments, the gaze directions 130, 132 and 134 are indicative of interaction of the shopper with products displays in the retail environment. Advantageously, by performing the gaze estimation as described above, a shopper's attention or interest towards the products may be effectively gauged. Further, such information may be utilized for adjusting a product advertising or market strategy in the retail environment.

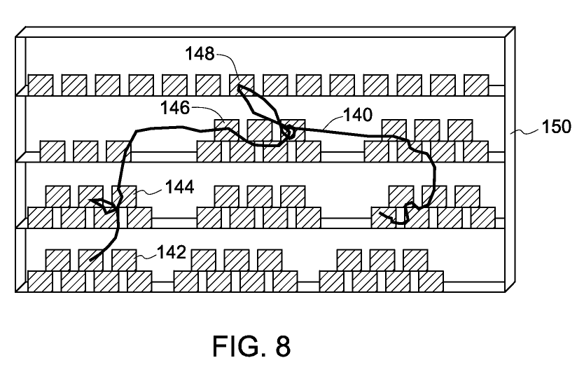

FIG. 8 depicts a gaze trajectory 140 of a shopper observing products in a retail environment. The gaze trajectory 140 is representative of interaction of the shopper with products such as represented by reference numerals 142, 144, 146 and 148 displayed in a shelf 150 of the retail environment. Advantageously, the gaze trajectory 140 provides information regarding what products or items are noticed by the shoppers. In certain embodiments, a location of certain products within the retail environment may be changed based upon this information. Alternatively, a design, quality or advertising of certain products may be changed based upon such information.

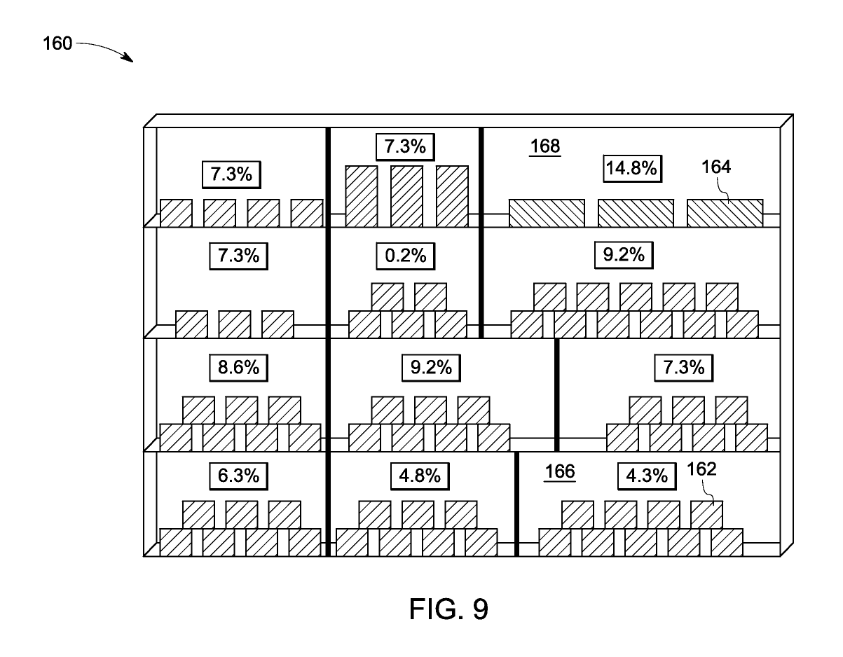

FIG. 9 depicts exemplary average time spent 160 by shoppers observing products such as 162 and 164 displayed in different areas such as 166 and 168. As can be seen, a shopper may interact with the products 162 displayed in area 166 for a relatively lesser time as compared to his interaction with the products 164 displayed in the area 168. Beneficially, such information may be utilized to determine the products that are unnoticed by the shopper and products that are being noticed but are ignored by the shopper. Again, a location, design, quality or advertising of certain products may be changed based upon such information.

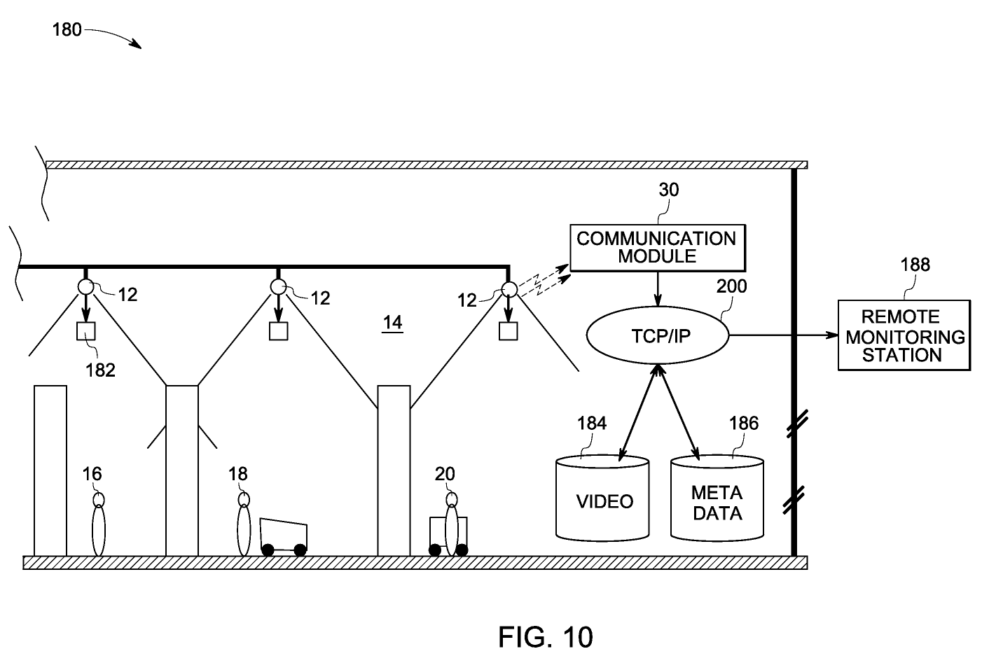

FIG. 10 is a schematic diagram of another embodiment of an adaptive advertising and marketing system 100. The system 100 includes the plurality of imaging devices 12 located at various locations in the environment 14. Each of the imaging devices 12 is configured to capture an image of the one or more individuals 16, 18 and 20 in the environment 14. Further, each of the imaging devices may include an edge device 182 coupled to the imaging device 12 for storing the captured images. The data from the edge devices 182 and any other information such as video 184 or meta data 186 may be communicated to a remote monitoring station 188 via Transmission control protocol/Internet protocol (TCP/IP) 200. Further, as described with reference to FIG. 1, the remote monitoring station 188 may include the video analytics system 22 to extract demographic and behavioral profiles of the one or more individuals 16, 18 and 20 from the received data. The demographic and behavioral profiles of the one or more individuals 16, 18 and 20 may be further utilized to change an advertising strategy of one or more products available in the environment 14.

The various aspects of the methods and systems described hereinabove have utility in a variety of retail applications. The methods and systems described above enable detection and tracking of shoppers in retail environments. In particular, the methods and systems discussed herein utilize an efficient, reliable, and cost-effective technique for obtaining information regarding behaviors of shoppers in retail environments. Further, the embodiments described above also provide techniques that enable real-time adjustment of the advertising and marketing strategy of the products based upon the obtained information.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method of adaptive advertising, comprising:
obtaining at least one of demographic and behavioral profiles of a plurality of individuals in an environment; and
adjusting an advertising strategy in the environment of one or more products based upon the demographic and behavioral profiles of the plurality of individuals.

2. The method of claim 1, wherein said obtaining demographic profiles comprises obtaining information related to age bands of the individuals, social class bands of the individuals, gender of the individuals, or a combination thereof.

3. The method of claim 2, further comprising obtaining information regarding location of each of the plurality of individuals in the environment.

4. The method of claim 1, wherein said obtaining behavioral profiles comprises estimating a gaze direction of each of the plurality of individuals.

5. The method of claim 4, wherein said estimating a gaze direction comprises:
capturing facial images of each of the plurality of individuals; and
fitting active appearance models to the captured facial images of the individuals.

6. The method of claim 5, comprising obtaining information regarding an articulated motion, a facial expression, or a combination thereof from the facial images of the individuals.

7. The method of claim 4, wherein said behavioral profiles comprise information related to interaction of individuals with the one or more products, products displays, or a combination thereof.

8. The method of claim 7, wherein the information related to interaction of individuals comprises time spent by individuals in browsing the products displays, time spent by individuals while interacting with the one or more products, number of eye gazes towards the one or more products or products displays, or a combination thereof.

9. The method of claim 1, comprising changing a location of the one or more products in the environment based upon the demographic and behavioral profiles of the individuals.

10. The method of claim 1, comprising changing a design, a quality, or a combination thereof of the one or more products based upon the demographic and behavioral profiles of the individuals.

11. A method of enhancing sales of one or more products in a retail environment, comprising:
obtaining information regarding behavioral profiles of a plurality of individuals visiting the retail environment;
analyzing the obtained information regarding the behavioral profiles of the individuals; and
changing at least one of an advertising strategy or a product marketing strategy of the one or more products in response to the information regarding the behavioral profiles of the plurality of individuals.

12. The method of claim 11, wherein said obtaining information comprises capturing a video imagery of the individuals interacting with the one or more products, product displays, or a combination thereof.

13. The method of claim 11, comprising obtaining information regarding number and location of the plurality of individuals visiting different sections of the retail environment.

14. The method of claim 11, wherein said obtaining information regarding the behavioral profiles comprises obtaining information related to interaction of the individuals with the one or more products or with product displays.

15. The method of claim 14, wherein the information related to interaction of individuals comprises gaze direction of the individuals, time spent by individuals in browsing the product displays, time spent by individuals while interacting with the one or more products, number of eye gazes towards the one or more products or the products displays, or a combination thereof

16. The method of claim 11, wherein said analyzing the obtained information comprises detecting a level of interest of the individuals towards the one or more products based upon the obtained information regarding the behavioral profiles of the individuals.

17. The method of claim 11, wherein said changing the advertising strategy comprises customizing the product displays based upon the behavioral profiles of the individuals.

18. The method of claim 11, wherein said changing the product marketing strategy comprises changing a location of the one or more products in the retail environment, changing a design or a quality of the one or more products, or a combination thereof.

19. An adaptive advertising and marketing system, comprising:
a plurality of imaging devices, each device being configured to capture an image of one or more individuals in an environment; and
a video analytics system configured to receive captured images from the plurality of imaging devices and to extract at least one of demographic and behavioral profiles of the one or more individuals to change at least one of an advertising or a product market strategy of one or more products.

20. The adaptive advertising and marketing system of claim 19, wherein the plurality of imaging devices comprises still cameras or video cameras disposed at a plurality of locations within the environment.

21. The adaptive advertising and marketing system of claim 19, wherein the demographic profiles comprise information related to age bands of the individuals, social class bands of the individuals, gender of the individuals, or a combination thereof.

22. The adaptive advertising and marketing system of claim 19, wherein the behavioral profiles comprise information related to interaction of the individuals with the one or more products or with product displays.

23. The adaptive advertising and marketing system of claim 22, wherein the information related to interaction of individuals comprises gaze direction of the individuals, time spent by individuals in browsing the product displays, time spent by individuals while interacting with the one or more products, number of eye gazes towards the one or more products or the products displays, or a combination thereof.

24. The adaptive advertising and marketing system of claim 22, wherein the video analytics system employs a statistical model configured to determine an emotional state of the individuals based upon the information related to interaction of the individuals with the one or more products or with the product displays.

25. The adaptive advertising and marketing system of claim 23, wherein the video analytics system is configured to estimate the gaze direction of the individuals by fitting a face model to facial images of the individuals.

26. The adaptive advertising and marketing system of claim 25, wherein the face model comprises an active appearance model (AAM).

27. The adaptive advertising and marketing system of claim 19, wherein the plurality of imaging devices are configured to obtain information regarding number and location of the one or more individuals visiting different sections of the environment.

28. The adaptive advertising and marketing system of claim 19, wherein the video analytics system comprises a processor configured to analyze the demographic and behavioral profiles of the one or more individuals and to develop a modified advertising or a product market strategy of the one ore more products.

29. The adaptive advertising and marketing system of claim 28, comprising a display coupled to the video analytics system and configured to display the modified advertising or a product market strategy of the one or more products.

30. The adaptive advertising and marketing system of claim 29, comprising a controller configured to control content of products displays of the one or more products based upon the modified advertising strategy.
